(19) United States
(12) Patent Application Publication
(10) Pub. No.: US 2024/0369099 A1
(43) Pub. Date: Nov. 7, 2024

(54) AXIAL ROLLING BEARING UNIT WITH ROLLING BODIES, WHICH ARE ARRANGED BETWEEN ANNULAR AXIAL BEARING WASHERS, AND A FUNCTIONALLY INTEGRATED BEARING CAGE

(71) Applicant: Schaeffler Technologies AG & Co. KG, Herzogenaurach (DE)

(72) Inventors: Wolfgang Fugel, Nürnberg (DE); Frank Schoenstein, Baiersdorf (DE); Andreas Kirschner, Aurachtal (DE)

(73) Assignee: Schaeffler Technologies AG & Co. KG, Herzogenaurach (DE)

(21) Appl. No.: 18/686,619

(22) PCT Filed: Aug. 23, 2022
(86) PCT No.: PCT/DE2022/100633

§ 371 Date: Feb. 26, 2024

(30) Foreign Application Priority Data
Sep. 9, 2021 (DE) 10 2021 123 371.2

(51) Int. Cl. F16C 19/30; F16C 33/54; F16C 33/66

(52) U.S. Cl. CPC F16C 19/305; F16C 33/546; F16C 33/6681

(57) ABSTRACT

An axial rolling bearing unit includes a first annular axial bearing washer, a second annular axial bearing washer, a bearing cage formed from a sheet metal material, and rolling elements arranged between the first annular axial bearing washer and the second annular axial bearing washer. The bearing cage includes an inner radial edge rim extending in an axial direction, and an outer radial edge rim extending in the axial direction. The rolling elements are radially guided by the inner radial edge rim and the outer radial edge rim. A one of the inner radial edge rim or the outer radial edge rim has a double-rim design with an end-side bend extending in a direction opposite to the axial direction, and the end-side bend has a first distal end section that holds the first annular axial bearing washer in a form-fitting manner.

### CROSS-REFERENCE TO RELATED APPLICATIONS

This application is the United States National Phase of PCT Appln. No. PCT/DE2022/100633 filed Aug. 23, 2022, which claims priority to German Application No. DE102021123371.2 filed Sep. 9, 2021, the entire disclosures of which are incorporated by reference herein.

### TECHNICAL FIELD

The present disclosure relates to a rolling bearing unit with rolling elements which are arranged between two annular axial bearing washers and which are guided by means of a bearing cage formed from a sheet metal material.

The field of application of the present disclosure extends primarily to automotive applications in which, for example, a shaft provided with helically toothed gears is subjected to an axial force which is to be absorbed by a suitable axial bearing relative to a transmission housing or the like.

### BACKGROUND

DE 103 13 183 A1 shows an axial rolling bearing unit of the type of interest here. In this disclosure, a collar is arranged on an outer peripheral edge of an axial bearing washer, which is extended by a flange. In a region composed of the collar and flange, a radially inwardly directed nose-like projection is formed, which engages radially behind the cage on the outer circumference. The other axial bearing washer is designed as an angled washer and engages behind the bearing cage on the inner circumference with an axial leg. This angular geometry of the axial bearing washers creates a self-retaining axial rolling bearing unit.

When mounting the bearing cage in the axial bearing washers, which are designed as angled washers, an unfavorable concentricity between the bearing cage and the axial bearing washer can occur, particularly in automated manufacturing. This can result in either bending of the bearing cage or shearing of the retaining lugs on the axial bearing washers. If not detected, this leads to a disturbed running behavior of the axial bearing and can even lead to failure of the entire bearing point. If the overlap between the axial bearing washer, which is designed as an angled washer, and the bearing cage is too small, the axial rolling bearing unit may even be dismantled as a result of vibration stress.

### SUMMARY

The present disclosure includes the technical teaching that the bearing cage of an axial rolling bearing unit formed from a sheet metal material has an inner and outer radial edge rim extending in the axial direction in order to radially guide the rolling elements. At least one of the edge rims is provided with an end-side bend in the opposite direction so as have a double-rim design, and the distal end section thereof has a rim border holding the associated axial bearing washer in a form-fitting manner.

The self-retaining structural unit is implemented by means of a specially constructed bearing cage which comprises the at least one axial bearing washer instead of vice versa, as in the prior art. This also opens up the possibility of using identical parts with regard to the annular axial bearing washers, which have an identical design. It is therefore not necessary to provide two different axial bearing washers per axial rolling bearing unit; instead, a total of three different components, namely the rolling elements, the bearing cage and the axial washers that can be used on both sides, are sufficient to implement the axial rolling bearing unit according to the disclosure. This simplifies both the manufacture and storage of individual parts.

According to an example embodiment of the bearing cage, the edge rim of the bearing cage lying opposite the double rim also has a distal end section with a rim border surrounding the other axial bearing washer in order to create an overall self-retaining structural unit using the bearing cage as a holding means. Here, the inner and outer radial edge rim encloses or surrounds an associated axial bearing washer in each case. In this regard, this enclosure or surround can be designed in such a way that the respective axial bearing washer is arranged with a radial movement clearance relative to the bearing cage that prevents component stresses. During assembly, this constructive design allows the individual parts to first be consolidated without incurring damage and then pressed together in the next step so that the rim borders fold over to form the structural unit. Since the structural unit according to the disclosure is largely closed all around by folding over the rim borders, unintentional dismantling can be ruled out.

In order to facilitate bending, the distal end sections of the edge rims may be wall-ironed by means of forming technology. This constriction of the edge rim creates a predetermined bending point, for example, because the edge rim is already pre-bent accordingly when the bearing cage produced by means of forming technology is deep-drawn. In this way, the material-weakening wall-ironing effect that is normally disadvantageous in deep drawing is used in an advantageous manner to create the predetermined bending point for the rim border.

In this context, the wall-ironed distal end section of the edge rim may be designed in such a way that an approximate form-fit results after the rim border is folded over onto the associated axial washer. This can be achieved by the axial bearing washers each being provided with an inner and outer radial edge shoulder which interacts with the respectively associated wall-ironed distal end section of the edge rim in such a way that the rim border bent over to form the enclosure does not project significantly beyond the outer side surface of the axial bearing washer, for example, resulting in a flat outer side surface. The inner and outer radial edge shoulder of the axial bearing washer may be produced by means of embossing. The annular axial bearing washers can therefore be produced from sheet metal material as stamped and embossed parts that are easy to manufacture. Although only one of the edge shoulders each of the axial bearing washers interacts with the bent-over rim border in the assembled state, the other edge shoulder can remain free without impairing the functionality of the axial rolling bearing unit. This compromise is made in favor of the above-mentioned identical part design of the axial bearing washers.

According to an alternative embodiment, the edge rim of the bearing cage surrounding the axial bearing washer can also be formed only in sections on part of the circumference. This means that the rim border does not have to be bent along the entire circumference during assembly, but only partially, which can be achieved with an appropriately designed bending die. This reduces the pressing forces required for assembly.

According to a further measure, it is proposed that a transition shoulder facing the respective axial bearing washer between the edge rim and the edge region of the bearing cage adjoining it and wall-ironed in relation to it forms a predetermined bending point for the enclosure of the axial bearing point. In other words, the wall-ironed edge region of thinner material is connected to the edge rim via the transition shoulder, which enables a closed right-angled outer geometry due to this alignment.

According to another aspect of the disclosure, it is proposed that the bearing cage formed from a sheet metal material has bearing webs which are spaced apart from one another in the circumferential direction and which serve to enclose the rolling elements and are each designed in the form of a sigma profile, so that the two inner and outer radial axially directed edge rims extend from one of the two axial bearing washers towards the other axial bearing washer. The generally known sigma profile originates on an axial side of the bearing cage with initially short radial sections facing one another, which are followed by inclined flank sections facing one another and culminating in a radially extending peak section, which in profile resembles the capital Greek letter sigma. A bearing cage formed in accordance with the disclosure can thus be used to implement such a sigma profile for shaping the bearing webs in order to enable precise guidance of the rolling elements on the one hand and to form the functionally integrated edge rims on the other, which, in addition to the radial guidance of the rolling elements, also form an enclosure for the axial bearing washers.

According to a further measure, it is proposed that the outer radial edge rim of the bearing cage is provided with lubricant breakthroughs arranged spaced apart from one another in the circumferential direction. The lubricant breakthroughs may be made in a circular shape by means of stamping and enable optimal lubrication of the rolling elements inside the bearing in order to minimize wear.

### BRIEF DESCRIPTION OF THE DRAWINGS

The disclosure is described in more detail below together with the description of two exemplary embodiments with reference to the figures. In the figures:

FIG. 1 shows a perspective partial section through an axial rolling bearing unit in the assembled state,

FIG. 2 shows a longitudinal section through the axial rolling bearing unit according to FIG. 1 in the assembled state,

FIG. 3 shows a longitudinal section through an axial rolling bearing unit of another embodiment in a partially assembled state, and

FIG. 4 shows a perspective longitudinal section through the partially assembled rolling bearing unit according to FIG. 3.

### DETAILED DESCRIPTION

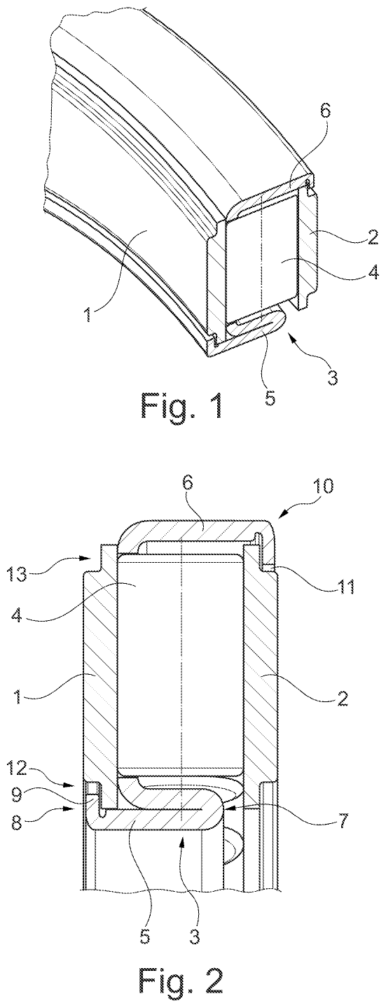

According to FIG. 1, the axial rolling bearing unit includes rolling elements 4 arranged between two opposing annular axial bearing washers 1 and 2, which are designed here as needles or roller bodies. The rolling elements 4 are guided by means of a bearing cage 3 formed from a sheet metal material. The bearing cage 3 has an inner radial and outer radial edge rim 5 or 6 extending in the axial direction in order to radially guide the rolling elements 4.

According to FIG. 2, the edge rim 5 is designed as a double rim and is provided with an end-side bend 7 in the opposite direction. The distal end section 8 of the edge rim 5 has an edge rim 9 that surrounds the associated axial bearing washer 1.

In order to create a self-retaining structural unit using the bearing cage 3 as a holding means, the edge rim 6 of the bearing cage 3 lying opposite the double rim also has a distal end section 10 with an edge rim 11 surrounding the other axial bearing washer 2.

The axial bearing washers 1 and 2 each have an (exemplary) inner and outer radial edge shoulder 12 or 13 which interacts with the respectively associated wall-ironed distal end section 8 or 10 of the respectively associated rim border 5 or 6. The rim border 9 or 11, which is bent over to form the enclosure or surround, does not project beyond the outer side surface of the respective axial bearing washer 1 or 2 in order to create a flat, end-face outer surface.

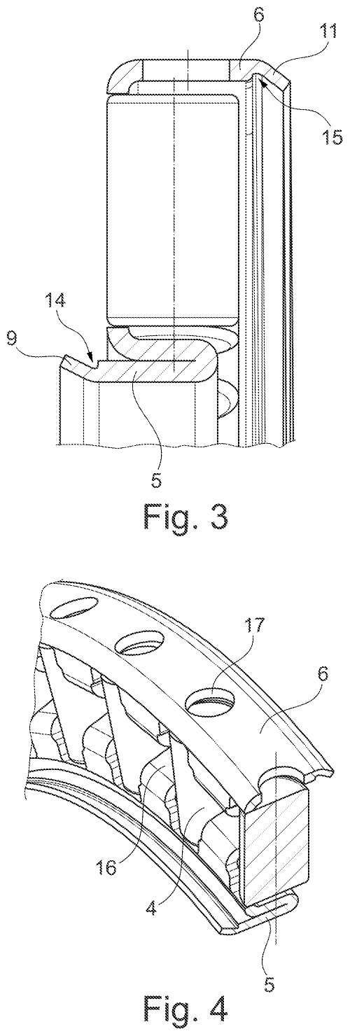

According to FIG. 3, a transition shoulder 14 or 15 facing the respective axial bearing washer—not shown further here—between the edge rim 5 or 6 and the edge region 9 or 11 adjoining it and wall-ironed in relation to it forms a predetermined bending point for the enclosure of the associated axial bearing washer.

According to FIG. 4, the bearing cage 3 formed from a sheet metal material has (exemplary) bearing webs 16 spaced apart from one another in the circumferential direction, which serve to enclose the rolling elements 4 to be guided spaced apart from one another and are each designed in the form of a sigma profile. This shape is the prerequisite for the two inner and outer radial axially directed edge rims 5 and 6 to extend from one of the two axial bearing washers towards the other axial bearing washer, as can be seen in the sectional view in FIG. 2.

Furthermore, the outer radial edge rim 6 of the bearing cage 3 is provided with several circular lubricant breakthroughs 17, which can be seen most clearly from this figure and are arranged spaced apart from one another in the circumferential direction, which are produced here by means of stamping.

### REFERENCE NUMERALS

1 First axial bearing washer
2 Second axial bearing washer
3 Bearing cage
4 Rolling elements
5 Inner radial edge rim
6 Outer radial edge rim
7 Bend
8 First distal end section
9 First rim border
10 Second distal end section
11 Second rim border
12 Inner radial edge shoulder
13 Outer radial edge shoulder
14 First transition shoulder
15 Second transition shoulder
16 Bearing web
17 Lubricant breakthrough

1. An axial rolling bearing unit with rolling elements which are arranged between two annular axial bearing washers and which are guided by means of a bearing cage formed from a sheet metal material, said bearing cage having an inner and outer radial edge rim extending in the axial direction in order to radially guide the rolling elements, wherein at least one of the edge rims is provided with an end-side bend in the opposite direction so as have a double-rim design, wherein a distal end section thereof is designed as a form-fitting holding means of the bearing cage for the at least one axial bearing washer.

2. The axial rolling bearing unit according to claim 1, wherein the distal end section has a rim border surrounding the associated axial bearing washer for holding it in a form-fitting manner, and the edge rim of the bearing cage lying opposite the double rim also has a distal end section with a rim border surrounding the other axial bearing washer in order to also hold the other axial bearing washer in a form-fitting manner with the bearing cage.

3. The axial rolling bearing unit according to claim 2, wherein at least one of the distal end sections of the edge rims is wall-ironed by means of forming technology in order to facilitate bending.

4. The axial rolling bearing unit according to claim 1, wherein the axial bearing washers each have an inner and outer radial edge shoulder which interacts with the respectively associated wall-ironed distal end section of the edge rim in such a way that the rim border bent over to form an enclosure does not project beyond an outer side surface of the axial bearing washers.

5. The axial rolling bearing unit according to claim 2, wherein the rim border of the bearing cage surrounding the axial bearing washer is only formed in sections on part of the circumference.

6. The axial rolling bearing unit according to claim 2,
wherein a transition shoulder facing the respective axial bearing washer between the edge rim and the rim border adjoining it and wall-ironed in relation to it forms a predetermined bending point for enclosure of the associated axial bearing washer.

7. The axial rolling bearing unit according to claim 1,
wherein both axial bearing washers are designed as identical parts.

8. The axial rolling bearing unit according to claim 1,
wherein the bearing cage formed from a sheet metal material has bearing webs which are spaced apart from one another in the circumferential direction and which serve to enclose the rolling elements and are each designed in the form of a sigma profile, so that the rims extend from one of the two axial bearing washers towards the other axial bearing washer.

9. The axial rolling bearing unit according to claim 1,
wherein the outer radial edge rim of the bearing cage is provided with lubricant breakthroughs arranged spaced apart from one another in the circumferential direction.

10. The axial rolling bearing unit according to claim 1,
wherein the annular axial bearing washers are also produced by means of forming technology from a sheet metal material as stamped and embossed parts.

11. An axial rolling bearing unit comprising:
a first annular axial bearing washer;
a second annular axial bearing washer;
a bearing cage formed from a sheet metal material, the bearing cage comprising:
an inner radial edge rim extending in an axial direction; and
an outer radial edge rim extending in the axial direction; and
rolling elements arranged between the first annular axial bearing washer and the second annular axial bearing washer, the rolling elements being radially guided by the inner radial edge rim and the outer radial edge rim, wherein:
a one of the inner radial edge rim or the outer radial edge rim comprises a double-rim design with an end-side bend extending in a direction opposite to the axial direction; and
the end-side bend comprises a first distal end section that holds the first annular axial bearing washer in a form-fitting manner.

12. The axial rolling bearing unit of claim 11 wherein the first annular axial bearing washer and the second annular axial bearing washer are identical.

13. The axial rolling bearing unit of claim 11, wherein the outer radial edge rim comprises circumferentially spaced lubricant breakthroughs.

14. The axial rolling bearing unit of claim 11 wherein:
the first annular axial bearing washer is stamped and embossed from sheet metal; and
the second annular axial bearing washer is stamped and embossed from sheet metal.

15. The axial rolling bearing unit of claim 11 wherein:
the first distal end section comprises a first rim border surrounding the first annular axial bearing washer; and
the other one of the inner radial edge rim or the outer radial edge rim comprises a second distal end section with a second rim border surrounding the second annular axial bearing washer to hold the second annular axial bearing washer in a form-fitting manner.

16. The axial rolling bearing unit of claim 15 wherein:
the first annular axial bearing washer comprises a first radial edge shoulder that interacts with the first distal end section such that the first rim border does not project beyond a first outer side surface of the first annular axial bearing washer; and
the second annular axial bearing washer comprises a second radial edge shoulder that interacts with the second distal end section such that the second rim border does not project beyond a second outer side surface of the second annular axial bearing washer.

17. The axial rolling bearing unit of claim 15, wherein:
the first rim border is formed of partial circumferential sections; or
the second rim border is formed from partial circumferential sections.

18. The axial rolling bearing unit of claim 15, wherein:
the bearing cage comprises circumferentially spaced bearing webs to enclose the rolling elements; and
each of the circumferentially spaced bearing webs is formed with a sigma profile such that:
the one of the inner radial edge rim or the outer radial edge rim extends from the second annular axial bearing washer towards the first annular axial bearing washer; and
the other one of the inner radial edge rim or the outer radial edge rim extends from the first annular axial bearing washer towards the second annular axial bearing washer.

19. The axial rolling bearing unit of claim 15, wherein the first distal end section or the second distal end section is wall-ironed by forming to facilitate bending.

20. The axial rolling bearing unit of claim 19, wherein:
the first distal end section is wall-ironed and a first transition shoulder facing the first annular axial bearing washer between the one of the inner radial edge rim or the outer radial edge rim and the first rim border forms a first predetermined bending point for enclosing the first annular axial bearing washer; or
the second distal end section is wall-ironed and a second transition shoulder facing the second annular axial bearing washer between the other one of the inner radial edge rim or the outer radial edge rim and the second rim border forms a second predetermined bending point for enclosing the second annular axial bearing washer.
